(19) United States
(12) Patent Application Publication
(10) Pub. No.: US 2006/0002437 A1
(43) Pub. Date: Jan. 5, 2006

(54) Method and optical arrangement for the generation of a broadband spectrum

(75) Inventors: Bernd Braun, Jena (DE); Andreas Zintl, Arnstadt (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: JENOPTIK Laser, Optik, Systeme GmbH

(21) Appl. No.: 11/166,026

(22) Filed: Jun. 23, 2005

(30) Foreign Application Priority Data
Jun. 30, 2004 (DE) 10 2004 032 463.8

(51) Int. Cl. H01S 3/10

(52) U.S. Cl. 372/22

(57) ABSTRACT

The invention is directed to a method and an optical arrangement for the generation of a broadband spectrum in which wavelength regions are selected in an application-oriented manner already during spectrum generation in order to provide increased laser power. A passively mode-coupled solid-state laser provides picosecond laser pulses with an infrared output wavelength which is transformed to a secondary wavelength in the visible spectral range by nonlinear optical processes. The picosecond laser pulses are coupled into a nonlinear optical fiber which is optically adapted to the secondary wavelength with respect to dispersion and nonlinear characteristics, so that a radiation output interval comprising a visible wavelength region is selectively generated. The broadband spectrum has high brilliance and can be used, for example, in spectroscopy, microscopy, cytometry or for array readers.

### CROSS-REFERENCE TO RELATED APPLICATION

This application claims priority of German Application No. 10 2004 032. 463.8, filed Jun. 30, 2004, the complete disclosure of which is hereby incorporated by reference.

### BACKGROUND OF THE INVENTION

a) Field of the Invention

The invention is directed to a method and an optical arrangement for the generation of a broadband spectrum which, due to its high brilliance, can be used, for example, in spectroscopy, microscopy, cytometry, or for array readers.

b) Description of the Related Art

When intensive short laser pulses pass through a nonlinear optical fiber, a considerable spectral distribution is brought about as a result of nonlinear optical processes and a so-called supercontinuum is generated.

Increasing interest has been generated in technical circles over the last few years by so-called photonic fibers (PCF=Photonic Crystal Fiber), photonic bandgap fibers or tapered fibers as a medium for spectral distributions of the type mentioned above.

Fibers of this kind comprise a crystal core surrounded by a series of microscopic air-filled or gas-filled cavities extending along the length of the fiber so that a honeycomb fiber structure is formed in cross section. Due to the size and arrangement of the hole structure, radiation can be guided into the fiber with a defined cross section on the one hand and the dispersion characteristics can be influenced in a deliberate manner on the other hand, which can lead to the desired nonlinear optical processes. Alternatively, photonic bandgap fibers are formed when a gas-filled cavity is also located in the fiber center and a substantial proportion of the radiation intensity is guided in the cavity.

Nonlinear effects essential to the generation of a supercontinuum include, above all, higher-order soliton effects, dispersion, stimulated Raman scattering, self-phase modulation, cross-phase modulation, and parametric four-wave mixing.

Initially, a focus of particular interest was continuum generation from femtosecond laser pulses which possess sufficiently high field intensities for the activation of the nonlinear optical processes in the fibers that are used. Studies in this area were carried out, for example, by Ranka, Windeler, Stentz, “Visible continuum generation in air-silica microstructure optical fibers with anomalous dispersion at 800 nm), Opt. Lett. 25, 25 (2000); Hartl, Li, Chudoba, Ghanta, Ko, Fujimoto, “Ultrahigh-resolution optical coherence tomography using continuum generation in an air-silica microstructure optical fiber”, Opt. Lett. 26, 608 (2001); and Holzwarth, Zimmermann, Udem, Hänsch, et al., “White-light frequency comb generation with a diode-pumped Cr:LiSAF laser”, Opt. Lett. 26, 1376 (2001).

In S. Coen, A. H. L. Chan, R. Leonhardt, J. D. Harvey, J. C. Knight, W. J. Wadsworth, P. St. J. Russell, “White-light supercontinuum generation with 60-ps pump pulses in a photonic crystal fiber”, Optics Letters 26 1356 (2001), it was shown that a spectrum which is expanded on both sides of the wavelength of the pump radiation source (647 nm) can also be generated with ps pulses.

All of these known solutions for generation of a supercontinuum are complicated in construction and are therefore large, maintenance-intensive and cost-intensive. This is particularly disadvantageous when a compact broadband radiation source with high brilliance is required, as is the case, e.g., for applications in medicine or biology (or in life science fields in general).

For this reason, in a known optical arrangement for providing a broadband spectrum according to WO 03/096490 A2, a passively mode-coupled solid-state laser serving to generate picosecond pulses is coupled with a photonic fiber. From the output wavelength in the infrared region, a broadband spectrum is generated whose wavelength range extends from 700 nm to 1000 nm below the output wavelength.

However, when an application requires only a partial region of the generated spectrum, a portion of the generated output remains unused.

### OBJECT AND SUMMARY OF THE INVENTION

Therefore, there is a need to select wavelength regions in an application-oriented manner already during spectrum generation in order to make increased laser power available.

This object is met in a method for the generation of a broadband spectrum by providing picosecond laser pulses with an infrared output wavelength, transforming the infrared output wavelength for generation of a secondary wavelength in the visible region, and coupling the picosecond laser pulses into a nonlinear optical fiber which is optically adapted to the secondary wavelength with respect to dispersion and nonlinear characteristics so that a radiation output interval which includes a visible wavelength region is selectively generated.

A radiation output interval in the visible wavelength range of 450 nm to 650 nm is preferably generated by the method according to the invention.

Further, the above-stated object is met according to the invention by an optical arrangement for generation of a broadband spectrum which has, in successive arrangement, a passively mode-coupled solid-state laser for providing picosecond laser pulses with an output wavelength in the infrared region, a nonlinear optical crystal for transformation of the infrared output wavelength in order to generate a secondary wavelength in the visible spectral region, and a nonlinear optical fiber which, by being optically adapted to the secondary wavelength, serves to generate a radiation output interval in the visible wavelength range, preferably from 450 nm to 650 nm.

Photonic fibers whose core diameter is less than 2 μm can be used, for example, as nonlinear optical fibers.

At a preferred output wavelength of 1064 nm, the secondary wavelength is 532 nm.

Compared to previously known arrangements, particularly from WO 03/096490 A2, the broadband spectrum in the present invention is selectively generated only in a range that is relevant for the area of application in question so that no power is wasted by subsequently filtering out parts of the spectrum.

The invention provides an economical and compact broadband radiation source which can be applied in a goal-oriented manner and is distinguished by an efficiently operating laser of simple construction. By using the nonlinear optical fiber that is specially optically adapted to the secondary wavelength, a significant distribution of the laser bandwidth can be selectively achieved with a principle component extending with essentially uniform intensity in the range between 450 nm and 650 nm. The invention accordingly shows that the pulse peak outputs for generating a broadband spectrum with suitably adapted zero-dispersion wavelength can be substantially lower than was previously known.

The invention will be described more fully in the following with reference to the schematic drawings.

### BRIEF DESCRIPTION OF THE DRAWINGS

In the drawings:

FIG. 1 shows an optical arrangement for a compact picosecond broadband radiation source with subsequent frequency doubling (second harmonic generation);

FIG. 2 shows a supercontinuum spectrum of the picosecond broadband radiation source according to FIG. 1; and

FIG. 3 shows a pump arrangement for a mode-coupled solid-state laser.

### DESCRIPTION OF THE PREFERRED EMBODIMENTS

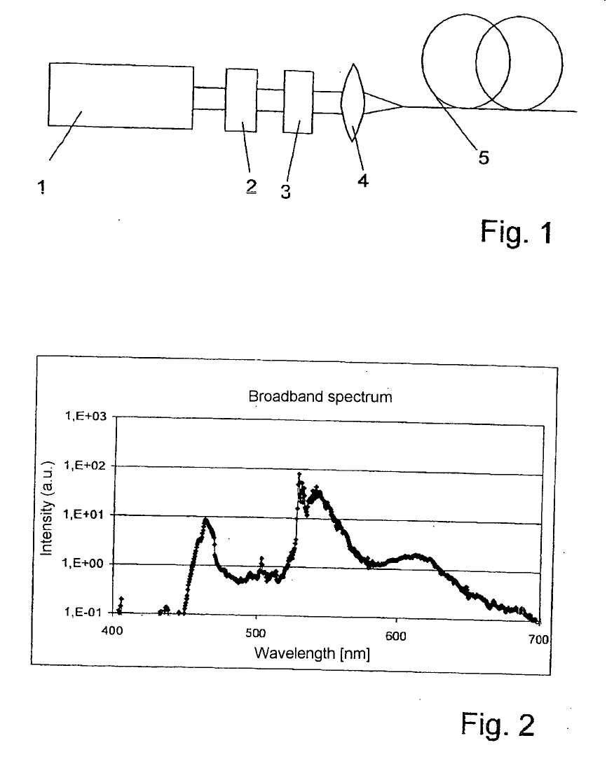

The broadband radiation source according to FIG. 1 comprises a passively mode-coupled solid-state laser 1 having a mode-coupled resonator operating with saturable semiconductor absorbers and with a plurality of deflecting mirrors and an end mirror and is protected against feedback by an optical isolator 2. A nonlinear optical crystal 3 is provided downstream of the solid-state laser 1 along the beam path for wavelength transformation to the visible spectral region. The radiation is coupled by in-coupling optics 4 with a frequency conversion element in the form of a nonlinear optical fiber 5, particularly a photonic fiber.

The solid-state laser 1 which has an average output power of 6 W supplies laser pulses in an output wavelength in the infrared region of λ=1064 nm with a pulse duration of about 9 ps whose spectral bandwidth is 0.3 nm. Further, the present embodiment example operates with a pulse repetition rate of 120 MHz, an average pulse energy of 50 nJ and an average pulse peak output of 5.8 kW. The output radiation is horizontally linearly polarized and the beam quality is M²=1.

The optical isolator 2 specified for the output wavelength, as optical diode, prevents back-reflected or scattered radiation from the nonlinear optical crystal 3, the in-coupling optics 4 and the nonlinear optical fiber 5 from feeding back into the resonator of the solid-state laser 1, which would lead to a sensitive interference of the mode coupling operation.

The nonlinear optical crystal 3 provided for wavelength transformation to the visible spectral region halves the output wavelength in the infrared region at λ_{A}=1064 nm resulting in a green secondary wavelength λ_{S}=532 nm.

With the in-coupling optics 4, for which an aspherical glass lens with a focal length of f=4.5 mm, a numerical aperture of NA=0.55 and an antireflection coating are used, a best-possible matching of the free beam parameters (beam radius and aperture angle of the Gaussian beam, TEM₀₀ of the solid-state laser 1) to the parameters of the fiber modes and, therefore, a maximum power in-coupling into the nonlinear optical fiber 5 is achieved (maximum in-coupling efficiency 50%). Lower-order excitation of determined fiber modes can be achieved in this way.

The nonlinear optical fiber 5, which has a length of 3 meters and is constructed in the present instance as a photonic fiber with a core diameter of 1.7 μm adapted to the green secondary wavelength in order to ensure zero dispersion and with a numerical aperture of NA=0.41, serves to distribute the spectral bandwidth of the laser pulses. Optical nonlinear characteristics which are highly pronounced to varying degrees, such as stimulated Raman scattering, self-phase modulation, cross-phase modulation, parametric four-wave mixing, soliton effects, dispersion and higher-order nonlinear effects, are responsible for this. The nonlinear optical fiber 5 is adapted to the secondary wavelength with respect to the optically nonlinear characteristics in such a way that the monochromatic laser radiation of 532 nm, green in the present embodiment example, is transformed into a spectrally broadband radiation in the visible spectral range of 450 nm to 650 nm, that is, a range of particular interest in life science fields.

As can be seen from FIG. 2, a broadband spectrum in which the majority of the radiation output interval is in a range from 450 nm and 650 nm is generated by the arrangement according to the invention.

Of course, the invention is not limited to the spectral region generated in the present embodiment example, since another spectral region can be generated at another output wavelength and resulting secondary wavelength by optically adapting the nonlinear optical fiber to this secondary wavelength.

The radiation source serving to provide the spectrum has a particularly simple, high-capacity construction, particularly with regard to the solid-state laser 1. The latter is pumped directly by a diode laser. A pump arrangement is provided which permits a particularly high pump power density without destroying the laser crystal.

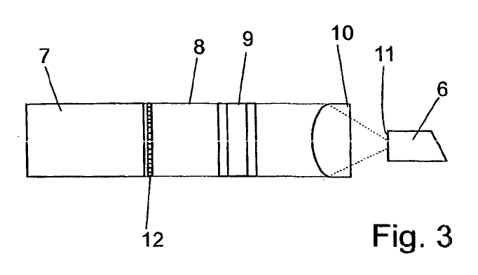

The pump arrangement shown in FIG. 3 contains a pump radiation source 7 in the form of a laser diode bar, or an arrangement thereof, for end-pumping a laser crystal 6. The pump beam 8 is directed to a beam entrance face 11 of the laser crystal 6 so as to be focused by means of two cylindrical lenses 9 and 10. When entering the laser crystal 6, the pump beam 7 is asymmetric in cross section with different dimensions perpendicular to one another. Microoptics 12 whose construction forms the beam parameters of the diode bar in x- and y-direction is arranged downstream of the pump radiation source 2.

While the foregoing description and drawings represent the present invention, it will be obvious to those skilled in the art that various changes may be made therein without departing from the true spirit and scope of the present invention.

1. A method for the generation of a broadband spectrum comprising the steps of:
providing picosecond laser pulses with an infrared output wavelength;
transforming the infrared output wavelength for generation of a secondary wavelength in the visible region; and
coupling the picosecond laser pulses into a nonlinear optical fiber which is optically adapted to the secondary wavelength with respect to dispersion and nonlinear characteristics so that a radiation output interval which includes a visible wavelength region is selectively generated.

2. The method according to claim 1, wherein a radiation output interval in the visible wavelength range from 450 nm to 650 nm is generated.

3. An optical arrangement for the generation of a broadband spectrum comprising, in successive arrangement:
a passively mode-coupled solid-state laser for providing picosecond laser pulses with an output wavelength in the infrared region;
a nonlinear optical crystal for transformation of the infrared output wavelength in order to generate a secondary wavelength in the visible spectral region; and
a nonlinear optical fiber which, by being optically adapted to the secondary wavelength, serves to generate a radiation output interval in the visible wavelength range.

4. The optical arrangement according to claim 3, wherein the radiation output interval is in the visible wavelength range from 450 m to 650 nm.

5. The optical arrangement according to claim 3, wherein a photonic fiber whose core diameter is less than 2 μm is provided as nonlinear optical fiber.

6. The optical arrangement according to claim 3, wherein the output wavelength is 1064 nm.

7. The optical arrangement according to claim 6, wherein the secondary wavelength is 532 nm.
